(19) United States
(12) Patent Application Publication
(10) Pub. No.: US 2026/0167891 A1
(43) Pub. Date: Jun. 18, 2026

(54) PROCESSES USING FISCHER-TROPSCH PRODUCTS

(71) Applicant: UOP LLC, Des Plaines, IL (US)

(72) Inventors: Krishan Pratap Jadaun, Rajasthan (IN); Richa Sharma, Haryana (IN)

(21) Appl. No.: 19/416,408

(22) Filed: Dec. 11, 2025

Related U.S. Application Data
(60) Provisional application No. 63/735,641, filed on Dec. 18, 2024.

(51) Int. Cl. C11C 3/12; C11B 3/00

(52) U.S. Cl. CPC C11C 3/12; C11B 3/00

(57) ABSTRACT

Processes integrating product streams from Fischer-Tropsch processes with other hydrocarbon processes, including fats, oils and greases (FOGs) to fuel, are described. In some cases, the Fischer-Tropsch product stream is separated into two or more streams before being sent to the later process, while in other cases the entire Fischer-Tropsch product stream is sent to the subsequent process.

### RELATED APPLICATIONS

This application claims priority to U.S. Provisional Patent Application Ser. No. 63/735,641, filed on Dec. 18, 2024, the entirety of which is incorporated herein by reference.

### BACKGROUND

As the demand for fuel increases worldwide, there is increasing interest in producing fuels and blending components from sources other than crude oil. Often referred to as a biorenewable source, these sources include, but are not limited to, plant oils such as corn, rapeseed, canola, soybean, microbial oils such as algal oils, animal fats such as inedible tallow, fish oils and various waste streams such as yellow and brown greases and sewage sludge. A common feature of these sources is that they are composed of glycerides and free fatty acids (FFA), and they are often collectively referred to as fats, oils, and greases (FOGs). Both triglycerides and the FFAs contain aliphatic carbon chains having from about 8 to about 24 carbon atoms. The aliphatic carbon chains in triglycerides or FFAs can be fully saturated, or mono, di or poly-unsaturated. The production of hydrocarbon products in the transport fuel boiling range can be achieved by hydroprocessing such biorenewable feedstock. Typical hydroprocessing of biorenewable feedstock can include hydrotreating, hydroisomerization and hydrocracking.

The Fischer-Tropsch process involves converting synthesis gas comprising carbon monoxide (and carbon dioxide) and hydrogen to hydrocarbons using a heterogeneous catalyst.

Fischer-Tropsch synthesis is known to yield a broad mixture of products including primarily paraffins, and some olefins. The individual compounds of such mixture can contain up to about 200 carbons. Typically, the number of carbons is between about 1 and about 150, with an average number of carbons of about 30. Some Fischer-Tropsch processes yield mixtures enriched with C₅-C₃₀ alkanes containing a significant quantity of olefins and oxygenated compounds, such as alcohols or acids. Trace amounts of sulfur-containing or nitrogen-containing products or aromatic compounds can be also present. Such mixtures are known as “light Fischer-Tropsch liquids” or “LFTL.” Both typical Fishcer-Tropsch product and LFTL are frequently used as a raw material for obtaining various petrochemical products, such as lubrication oil, kerosene, petroleum distillates, or diesel fuels, among others. The Fischer-Tropsch products are also commonly known as Fischer-Tropsch crude and typically go through further separation and upgrading processes.

In some existing processes, the Fischer-Tropsch crude feed is hydrocracked, hydro-isomerized/dewaxed, and separated into one or more product streams. To increase the yield of lighter products, such as transportation fuels, the unconverted oil stream from the separation is recycled to the hydrocracking reaction zone, resulting in it being highly dewaxed due to multiple passes over the dewaxing catalyst.

Therefore, there is a need for improved processes for converting Fischer-Tropsch liquids and waxes into transportation fuels. The Fischer Tropsch crude feed upgrade unit can be improved to integrate and intensify upgrading of other biorenewable feedstocks such as FOGs.

### BRIEF DESCRIPTION OF THE DRAWINGS

FIGS. 1A-1C are illustrations of three embodiments of one process according to the present invention.

FIGS. 2A-2C are illustrations of three embodiments of another process according to the present invention.

FIGS. 3A-3C are illustrations of three embodiments of another process according to the present invention.

FIG. 4 is an illustration of an embodiments of another process according to the present invention.

FIG. 5 is illustrations of an embodiment of another process according to the present invention.

### DESCRIPTION

The invention provides an opportunity for FT complex operators to co-process fats, oils, and greases (FOGs) in their units and increase the SAF volume at lower capital and operating cost.

Additionally, another aspect of the present invention allows FT Distillate to be co-processed in a hydrodeoxygenation (HDO) reactor for better heat management.

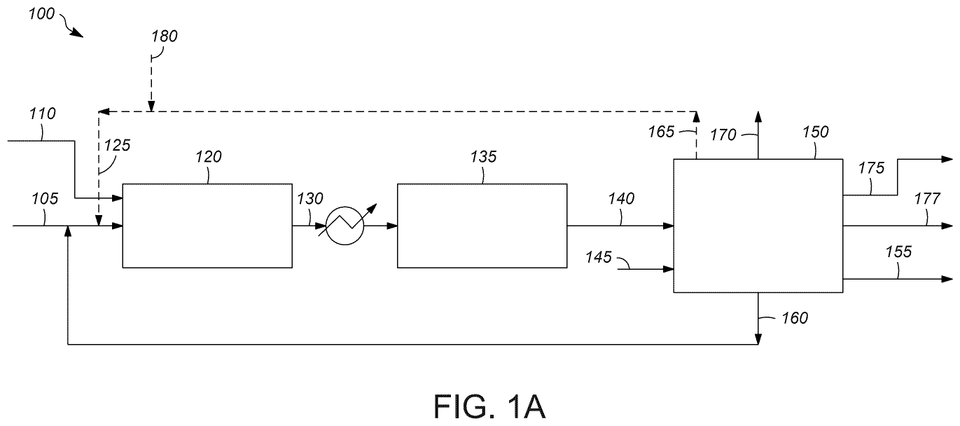

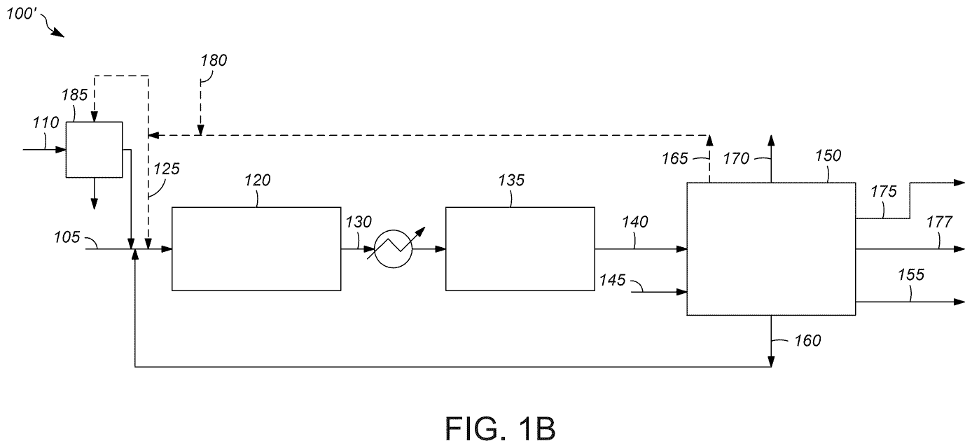

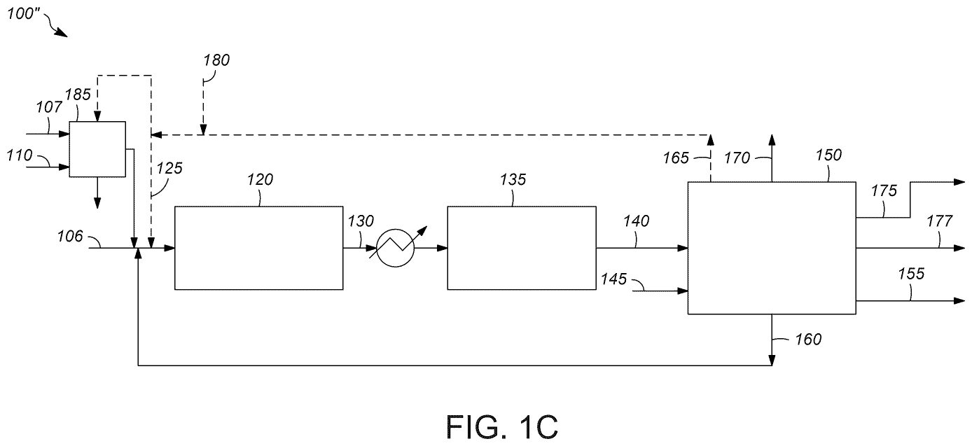

FIG. 1A illustrates a process 100 for co-processing Fischer-Tropsch products and FOGs to produce synthetic paraffinic kerosene which can be turned into sustainable aviation fuel. The Fischer-Tropsch crude feed stream 105 comprises Fischer-Tropsch products comprising C₅-C₁₀₀ normal paraffins.

The Fischer-Tropsch crude feed stream 105 and the FOGs stream 110 comprising C₅-C₁₀₀ FOGs are sent to the hydrocracking reaction zone 120 along with a hydrogen recycle stream 125 where the C₅ to C₁₀₀ normal paraffins are hydrocracked to C₅ to C₂₀ paraffins.

The hydrocracking reaction zone 120 has multiple beds to manage the temperature rise. The hydrocracking reaction zone 120 comprises one or more hydrocracking reactors, and each hydrocracking reactor can have one or more beds. A single hydrocracking reactor would have more than one bed. If there are two or more hydrocracking reactors, each reactor could have a single bed or multiple beds.

The hydrocracking reaction zone 120 includes a hydrocracking catalyst. Any hydrocracking catalyst suitable for hydrocracking the Fischer-Tropsch crude feed and FOG can be used The hydrocracking catalyst may comprise an acidic component, including, but not limited to, an amorphous acidic component such as amorphous silica-alumina (ASA). The hydrocracking catalyst may comprise a noble metal. Noble metals include, but are not limited to, Au, Ag, Pt, Pd, Ru, Rh, Pd, Os, and Ir. One suitable hydrocracking catalyst comprises a noble metal and ASA which provides high middle distillate selectivity. In another embodiment, a suitable hydrocracking catalyst comprises a noble metal and crystalline acidic components such as a faujasite-based ultra-stable Y-zeolite and/or a beta zeolite. Typically, Fischer-Tropsch product stream does not contain sulfur or nitrogen organic components that significantly affect the noble metal functioning. However, when Fischer-Tropsch products comprise higher concentrations of oxygenates utilizing a hydrocracking catalyst comprising base metal may be advantageous. So, yet in another embodiment a suitable hydrocracking catalyst comprises ASA, a crystalline acidic component and the aforementioned base metals. In some embodiment, the hydrocracking catalyst comprises an acidic component that is only amorphous.

The hydrocracking reaction conditions include a temperature in the range of 315° C. to 415° C., and a pressure in the range of 300 to 1000 psig.

The hydrocracked effluent stream 130 comprises C₅-C₂₀ normal paraffins.

The hydrocracked effluent stream 130 is sent to the dewaxing reaction zone 135 where a portion of the C₅ to C₂₀ normal paraffins are converted to C₅ to C₂₀ isoparaffins. The dewaxing reaction zone 135 comprises one or more dewaxing reactors.

The dewaxing reaction zone 135 contains a dewaxing catalyst. Any catalyst suitable for isomerizing the hydrocracked Fischer-Tropsch product stream can be used. One example of a suitable dewaxing catalyst comprises a noble metal and SAPO-11. Noble metals are described above. The catalyst hydroisomerizes n-paraffins in diesel (C9-C30) and kerosene (C9-C20) carbon number ranges into iso-paraffins to meet cold flow property specifications, such as those found in ASTM D 7566.

The dewaxing reaction conditions include a temperature in the range of 315° C. to 400° C., and a pressure in the range of 300 psig to 1000 psig.

The dewaxing effluent stream 140 comprises C₅-C₂₀ normal paraffins and isoparaffins.

The dewaxing effluent stream 140 and steam stream 145 are sent to the product recovery zone 150. The product recovery zone 150 comprises one or more fractionation columns. The dewaxing effluent stream 140 is separated into one or more product streams. For example, the product recovery zone 150 can produce at least a synthetic paraffinic kerosene stream 155 comprising C₈-C₂₀ normal paraffins and isoparaffins, and an unconverted oil stream 160 comprising C₂₁₊ normal paraffins and isoparaffins. Additional streams can be produced, including, but not limited to, a hydrogen stream 165, or a fuel gas stream 170 comprising fuel gas and liquified petroleum gas, or a naphtha stream 175 comprising C₅-C₈ normal paraffins and isoparaffins, or a heavy naphtha stream 177 comprising C₇-C₁₂ hydrocarbons, or combinations thereof. The hydrogen stream 165 can be combined with the hydrogen recycle stream 125 and makeup hydrogen stream 180. The naphtha stream 175 can be blended into a gasoline pool used for automotive fuel. The naphtha stream 175 contains very low concentrations of aromatics, olefins, and sulfur. In another embodiment, either the naphtha stream 175 or the heavy naphtha stream 177 or both can be utilized as a feed stream to a thermal steam cracker and converted into olefins. In yet another embodiment, either the naphtha stream 175 or the heavy naphtha stream 177 or both can be converted into a synthesis gas comprising carbon monoxide and hydrogen. In a further embodiment, either the naphtha stream 175 or the heavy naphtha stream 177 or both can be burned as a fuel within the current invention in the hydrocracking reaction zone 120 or the dewaxing reaction zone 135, or in the product recovery zone 150, or in any combination thereof. Other separations could be performed as known to those of skill in the art.

The unconverted oil stream 160 is recycled to the hydrocracking reaction zone 120.

In FIG. 1B, the Fischer-Tropsch crude feed stream 105 comprises Fischer-Tropsch products comprising C₅-C₁₀₀ normal paraffins. The FOGs stream 110 and hydrogen recycle stream 125 are sent to a demetallizing and hydrodeoxygenating reaction zone (DEMET/HDO) 185 where it is demetallized and hydrodeoxygenated before being sent to the hydrocracking reaction zone 120.

In FIG. 1C, the heavy Fischer-Tropsch crude feed stream 106 comprises a Fischer-Tropsch wax comprising C₁₂-C₁₀₀ normal paraffins. The Fischer-Tropsch distillate stream 107 comprising C₅-C₃₀ normal paraffins.

The heavy Fischer-Tropsch crude feed stream 106 is sent to the hydrocracking reaction zone 120. The Fischer-Tropsch distillate stream 107 and FOGs stream 110 are sent to the DEMET/HDO unit 185 before being sent to the hydrocracking reaction zone 120.

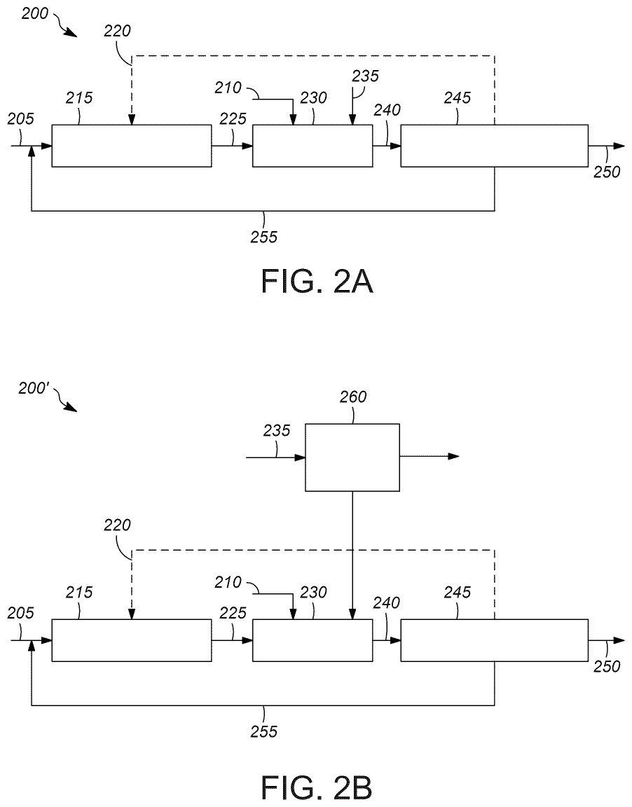

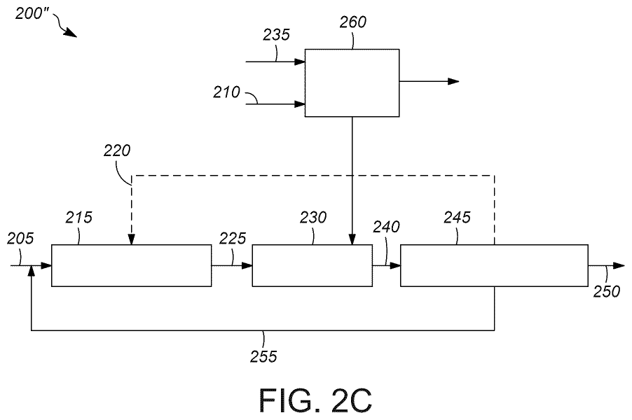

FIG. 2A illustrates another embodiment of a process 200 for co-processing Fischer-Tropsch products and FOGs to produce synthetic paraffinic kerosene. In this arrangement, there is a Fischer-Tropsch product stream 205 comprising C₅-C₁₀₀ and a Fischer-Tropsch distillate stream 210 comprising C₅-C₃₀ normal paraffins.

The Fischer-Tropsch product stream 205 and recycle hydrogen stream 220 are sent to the hydrocracking reaction zone 215 where the Fischer-Tropsch wax is hydrocracked to C₅-C₂₀ normal paraffins and isoparaffins.

The hydrocracked effluent stream 225 is sent to the dewaxing reaction zone 230, along with the Fischer-Tropsch distillate stream 210 and the FOGs stream 235 where a portion of the C₅-C₂₀ normal paraffins are converted to C₅-C₂₀ isoparaffins.

The dewaxing effluent 240 comprising C₅-C₂₀ normal paraffins and isoparaffins is sent to the product recovery zone where it is separated into one or more streams including synthetic paraffinic kerosene stream 250 comprising C₈-C₂₀ normal paraffins and isoparaffins, and an unconverted oil stream 255 comprising C₂₁₊ normal paraffins and isoparaffins. Additional streams could be produced, as discussed above.

In FIG. 2B, the FOGs stream 235 is sent to a DEMET/HDO unit 260 before being sent to the dewaxing reaction zone 230.

In FIG. 2C, the FOGs stream 235 and Fischer-Tropsch distillate stream 210 are both sent to the DEMET/HDO unit 260 before being sent to the dewaxing reaction zone 230.

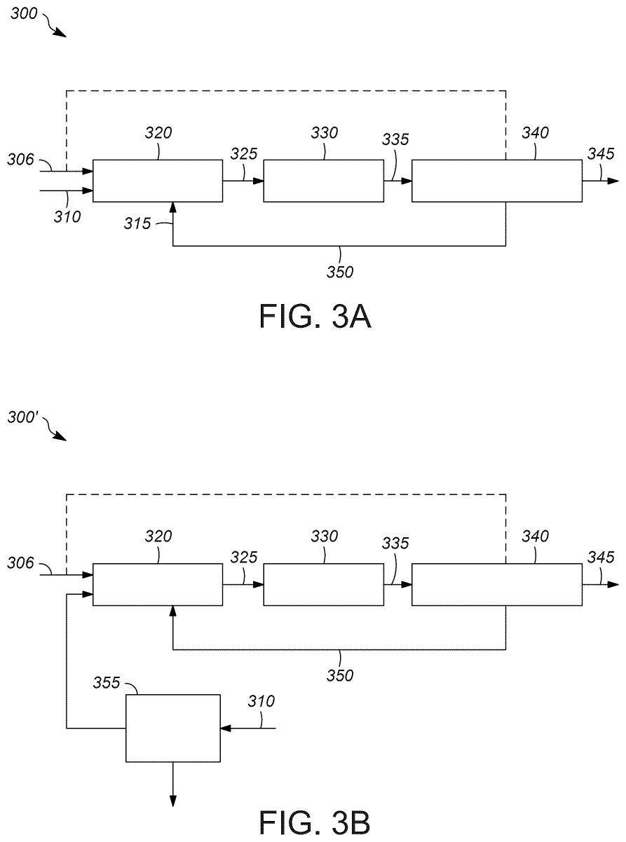

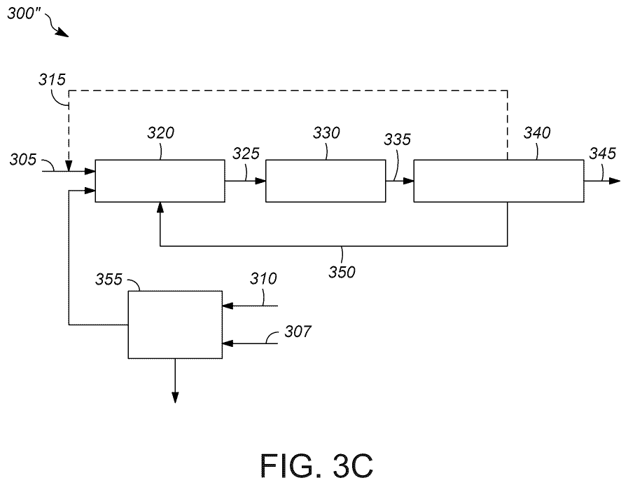

In the process 300 shown in FIG. 3A, the Fischer-Tropsch distillate feed stream 306 comprises Fischer-Tropsch distillate C₅-C₃₀ normal paraffins. The Fischer-Tropsch distillate feed stream 306, the FOGs stream 310, and recycle hydrogen stream 315 are sent to the dewaxing reaction zone 320 where a portion of the C₅-C₃₀ paraffins and FOGs are converted to C₅-C₃₀ isoparaffins.

The dewaxed effluent stream 325 is hydrocracked in the hydrocracking reaction zone 330 to form C₅-C₂₀ normal paraffins and isoparaffins.

The hydrocracked effluent 335 is sent to the product recovery zone 340 where it is separated into one or more streams including least a synthetic paraffinic kerosene stream 345 comprising C₈-C₂₀ normal paraffins and isoparaffins, and an unconverted oil stream 350 comprising C₂₁₊ normal paraffins and isoparaffins.

In FIG. 3B, the Fischer-Tropsch distillate feed stream 306 comprises C₈-C₃₀ normal paraffins. The FOGs stream 310 is sent to a DEMET/HDO unit 355 before being sent to the dewaxing reaction zone 320.

In FIG. 3C, the Fischer-Tropsch crude feed stream 305 comprises C₅-C₁₀₀ normal paraffins and the Fischer-Tropsch distillate stream 307 comprises C₅-C₃₀ normal paraffins. The FOGs stream 310 and the Fischer-Tropsch distillate stream 307 are sent to the DEMET/HDO unit 355 before being sent to the dewaxing reaction zone 320.

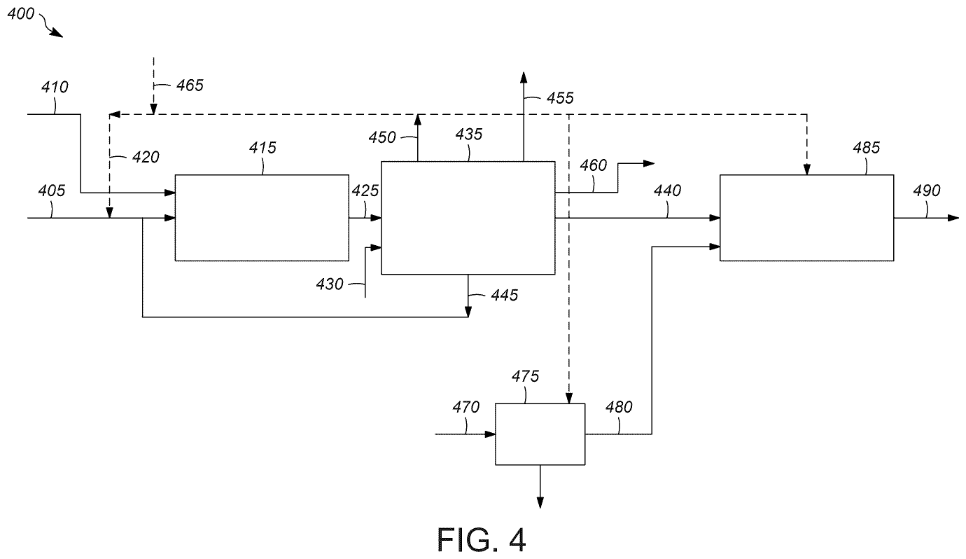

FIG. 4 illustrates a process 400 for co-processing Fischer-Tropsch oil and FOGs to produce synthetic paraffinic kerosene. The Fischer-Tropsch crude feed stream 405 comprises C₅-C₁₀₀ paraffins.

The Fischer-Tropsch crude feed stream 405 and the FOGs stream 410 are sent to the hydrocracking reaction zone 415 along with a recycle hydrogen stream 420 where the C₅-C₁₀₀ normal paraffins are hydrocracked to C₅-C₂₀ normal paraffins.

The hydrocracking reaction zone 415 has multiple beds to manage the temperature rise. The hydrocracking reaction zone 415 comprises one or more hydrocracking reactors, and each hydrocracking reactor can have one or more beds. A single hydrocracking reactor would have more than one bed. If there are two or more hydrocracking reactors, each reactor could have a single bed or multiple beds.

The hydrocracking reaction zone 415 includes a hydrocracking catalyst. Any hydrocracking catalyst suitable for hydrocracking the Fischer-Tropsch crude feed and FOG can be used. The hydrocracking reaction zone includes a hydrocracking catalyst. Any hydrocracking catalyst suitable for hydrocracking the Fischer-Tropsch crude feed can be used. The hydrocracking catalyst may comprise an acidic component, including, but not limited to, an amorphous acidic component such as amorphous silica-alumina (ASA). The hydrocracking catalyst may comprise a noble metal. Noble metals include, but are not limited to, Au, Ag, Pt, Pd, Ru, Rh, Pd, Os, and Ir. One suitable hydrocracking catalyst comprises a noble metal and ASA which provides high middle distillate selectivity. In another embodiment, a suitable hydrocracking catalyst comprises a noble metal and crystalline acidic components such as a faujasite-based ultra-stable Y-zeolite and a beta zeolite. Typically, Fischer-Tropsch product stream does not contain sulfur or nitrogen organic components that significantly affect the noble metal functioning. However, when Fischer-Tropsch products comprise higher concentrations of oxygenates utilizing a hydrocracking catalyst comprising base metal may be advantageous. So, yet in another embodiment a suitable hydrocracking catalyst comprises ASA, a crystalline acidic component and the aforementioned base metals. In some embodiment, the hydrocracking catalyst an acidic component that is only amorphous.

The hydrocracking reaction conditions include a temperature in the range of 315° C. to 415° C., and a pressure in the range of 300 to 1000 psig.

The hydrocracked effluent stream 425 comprises C₅-C₂₀ normal paraffins.

The hydrocracked effluent stream 425 from the hydrocracking reaction zone 415 and a steam stream 430 are sent to the product recovery zone 435. The product recovery zone 435 comprises one or more fractionation columns. The hydrocracked effluent stream 425 is separated into one or more product streams. For example, the product recovery zone 435 can produce at least a synthetic paraffinic kerosene stream 440 comprising C₈ to C₂₀ normal paraffins and isoparaffins, and an unconverted oil stream 445 comprising C₂₁₊ paraffins. Additional streams can be produced, including, but not limited to, a hydrogen stream 450, a fuel gas stream 455 comprising fuel gas and liquefied petroleum gas, and a naphtha stream 460 comprising C₅-C₈ paraffins. The hydrogen stream 450 can be combined with the recycle hydrogen stream 420 and makeup hydrogen stream 465. The naphtha stream 460 can be hydrogen recycle stream 125 and makeup hydrogen stream 465. The naphtha stream 460 can be blended into a gasoline pool used for automotive fuel. The naphtha stream contains very low concentrations of aromatics, olefins, and sulfur. In another embodiment, the heavy naphtha stream can be utilized as a feed stream to thermal steam cracker and converted into olefins. In yet another embodiment, the heavy naphtha can be converted into a synthesis gas comprising carbon monoxide and hydrogen. In a further embodiment, the heavy naphtha can be burned as a fuel within the current invention in the hydrocracking reaction zone 415 or the dewaxing reaction zone 485, or in the product recovery zone 435, or in any combination thereof. Other separations could be performed as known to those of skill in the art.

The unconverted oil stream 445 is recycled to the hydrocracking reaction zone 415.

The second FOGs stream 470 is treated in DEMET/HDO unit 475.

The synthetic paraffinic kerosene stream 440, treated FOGs stream 480, and the recycle hydrogen stream 420 are sent to the dewaxing reaction zone 485 where a portion of the C₈ to C₂₀ normal paraffins is converted to C₈ to C₂₀ isoparaffins. The dewaxing reaction zone 485 comprises one or more dewaxing reactors.

The dewaxing reaction zone 485 contains a dewaxing catalyst. Any catalyst suitable for isomerizing the hydrocracked Fischer-Tropsch crude feed and FOGs can be used. One example of a suitable dewaxing catalyst comprises a noble metal and SAPO-11. Noble metals are described above. The catalyst is specific for renewable aviation and diesel applications, and it hydro-isomerizes n-paraffins in diesel and kerosene carbon number ranges into iso-paraffins to meet cold flow property specifications, such as those found in ASTM D 7566. It has very high retention of C₈ to C₂₀ isoparaffins that produce diesel and kerosene, very little naphtha generation, and it produces significant improvement of cold flow properties.

The dewaxing reaction conditions include a temperature in the range of 315° C. to 400° C., and a pressure in the range of 300 psig to 1000 psig.

The dewaxing effluent stream 490 comprises synthetic paraffinic kerosene.

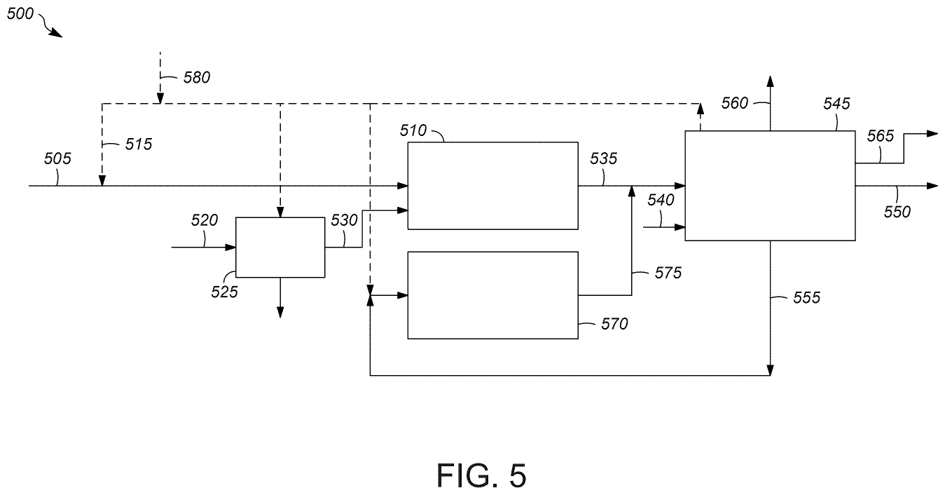

FIG. 5 illustrates a process 500 for co-processing Fischer-Tropsch products and FOGs to produce synthetic paraffinic kerosene which can turned into sustainable aviation fuel. The Fischer-Tropsch crude feed stream 505 comprises comprising C₅-C₁₀₀ normal paraffins.

The Fischer-Tropsch crude feed stream 505 is sent to the dewaxing reaction zone 510 along with a recycle hydrogen stream 515 where a portion of the normal paraffins are converted to isoparaffins.

The FOGs stream 520 is treated in DEMET/HDO unit 525, and the treated FOGs stream 530 is sent to the dewaxing reaction zone 510.

The dewaxing effluent stream 535 and steam stream 540 are sent to the product recovery zone 545. The product recovery zone 545 comprises one or more fractionation columns. The dewaxing effluent stream 535 is separated into one or more product streams. For example, the product recovery zone 545 can produce at least synthetic paraffinic kerosene stream 550 comprising C₈-C₂₀ normal paraffins and isoparaffins, and an unconverted oil stream 555 comprising C₂₁₊ normal paraffins and isoparaffins. Additional streams can be produced, including, but not limited to, the recycle hydrogen stream 515, a fuel gas stream 560 comprising fuel gas and liquefied petroleum gas, and a naphtha stream 565 comprising C₅-C₈ normal paraffins and isoparaffind. The naphtha stream 565 can be blended into a gasoline pool used for automotive fuel. The naphtha stream contains very low concentrations of aromatics, olefins, and sulfur. In another embodiment, the heavy naphtha stream can be utilized as a feed stream to thermal steam cracker and converted into olefins. In yet another embodiment, the heavy naphtha can be converted into a synthesis gas comprising carbon monoxide and hydrogen. In a further embodiment, the heavy naphtha can be burned as a fuel within the current invention in the dewaxing reaction zone 510, or the hydrocracking reaction zone 570, or in the product recovery zone 545, or in any combination thereof. Other separations could be performed as known to those of skill in the art.

The unconverted oil stream 555 is sent to a hydrocracking reaction zone 570 along with recycle hydrogen stream 515 where the C₂₁₊ paraffins are hydrocracked to C₅-C₂₀ paraffins.

The hydrocracking reaction zone 570 has multiple beds to manage the temperature rise. The hydrocracking reaction zone 570 comprises one or more hydrocracking reactors, and each hydrocracking reactor can have one or more beds. A single hydrocracking reactor would have more than one bed. If there are two or more hydrocracking reactors, each reactor could have a single bed or multiple beds.

The hydrocracking reaction zone includes a hydrocracking catalyst. Any hydrocracking catalyst suitable for hydrocracking the Fischer-Tropsch crude feed can be used. The hydrocracking reaction zone includes a hydrocracking catalyst. Any hydrocracking catalyst suitable for hydrocracking the Fischer-Tropsch crude feed can be used. The hydrocracking catalyst may comprise an acidic component, including, but not limited to, an amorphous acidic component such as amorphous silica-alumina (ASA). The hydrocracking catalyst may comprise a noble metal. Noble metals include, but are not limited to, Au, Ag, Pt, Pd, Ru, Rh, Pd, Os, and Ir. One suitable hydrocracking catalyst comprises a noble metal and ASA which provides high middle distillate selectivity. In another embodiment, a suitable hydrocracking catalyst comprises a noble metal and crystalline acidic components such as a faujasite-based ultra-stable Y-zeolite and a beta zeolite. Typically, Fischer-Tropsch product stream does not contain sulfur or nitrogen organic components that significantly affect the noble metal functioning. However, when Fischer-Tropsch products comprise higher concentrations of oxygenates utilizing a hydrocracking catalyst comprising base metal may be advantageous. So, yet in another embodiment a suitable hydrocracking catalyst comprises ASA, a crystalline acidic component and the aforementioned base metals. In some embodiment, the hydrocracking catalyst an acidic component that is only amorphous.

The hydrocracking reaction conditions include a temperature in the range of 315° C. to 415° C., and a pressure in the range of 300 to 1000 psig.

The hydrocracked effluent stream 575 from the hydrocracking reaction zone 570, which comprises C₅-C₂₀ normal paraffins and isoparaffins, is sent to the product recovery zone 545.

Make up hydrogen stream 580 is combined with recycle hydrogen stream 515.

### EXAMPLES

### Example 1

A Fischer-Tropsch crude blend feed was processed in a recycling hydroprocessing unit with a hydrocracking reactor and a dewaxing reactor. The dewaxing reactor effluent was fractionated to remove light products and unconverted oil to obtain a kerosene cut. The unconverted oil was recycled to extinction. The hydroprocessing unit was loaded with commercial Honeywell UOP FT-Unicracking™ catalyst and operated at appropriate conditions to maximize the kerosene yield. The property of kerosene stream produced is listed in Table 1. Both the density and cold flow property meet FT-SPK (Fischer-Tropsch-synthetic paraffinic kerosene) requirements listed in ASTM D7566.

### Example 2

A soybean oil stream was processed in a hydro-deoxygenation reactor at appropriate conditions. Water and acid gas were removed from the hydro-deoxygenation reactor effluent to produce a hydrocarbon steam. The hydrocarbon stream was processed in a dewaxing reactor loaded with the same dewaxing catalyst in Example 1 and operated at suitable conditions. The effluent from dewaxing reactor was fractionated to remove light products and unconverted oil to obtain a kerosene cut. The properties of this kerosene stream are listed in Table 1. It can be seen that while the kerosene satisfies density requirements mentioned in ASTM D7566 for HEFA-SPK (hydrotreated esters and fatty acids-synthetic paraffinic kerosene), there is still room for distillation End Point to accommodate higher boiling point products.

### Comparative Example 2

The soybean oil stream was processed in the same way as described in Example 2, except that the reaction and fractionation conditions were adjusted to obtain a different fractionation end point of the kerosene stream. The property of this kerosene stream is also listed in Table 1. The results showed that when the kerosene stream distillation End Point is increased, the yield of kerosene is higher than example 2, but the density is outside of the requirements of HEFA-SPK specified in ASTM D7566.

### Example 3

A soybean oil stream was hydro-deoxygenated as described in Example 2. After removal of water and acid gas, the hydrocarbon stream was blended with the Fischer-Tropsch Crude blend feed used in Example 1. The blending ratio was adjusted such that the weight ratio of starting soybean oil stream to the Fischer-Tropsch Crude blend stream was 40:60. A simulation for the combined stream processed in the recycling hydroprocessing and fractionation unit described in Example 1 at appropriate conditions was run. The properties for the kerosene stream obtained from the blend are listed in Table 1. When the distillation End Point approaches ASTM D7566 limits, the cold-flow property and density of the co-processed product stream are still within the limits of FT-SPK and HEFA-SPK. The co-processing also resulted in substantial kerosene yield improvements, since the process can still stay within the desired specification when the distillation end point is closer to those listed in ASTM D7566.

TABLE 1

| | | ASTM D7566 | | | | | |
|---|---|---|---|---|---|---|---|
| | | Specification | | | | | |
| | | | HEFA- | Example | Example | Comparative | Example |
| | | FT-SPK | SPK | 1 | 2 | Example 2 | 3 |
| Freeze Point | | <−40° C. | <−40° C. | −52° C. | −77.8° C. | −60° C. | <−50° C. |
| ASTM D86 | 10% | <205 | <205 | 137.0 | 92.0 | 121.9 | 126.7 |
| distillation | 50% | — | — | 236.0 | 232.0 | 272.6 | 251.6 |
| (° C.) | FBP | <300 | <300 | 298.0 | 292.2 | 296.1 | 298.4 |

| | | | | | | |
|---|---|---|---|---|---|---|
| Density at 15° C., | 0.730 to | 0.730 to | 0.761 | 0.772 | 0.780 | 0.769 |
| gram/ml | 0.770 | 0.772 | | | | |
| Kerosene Yield | — | — | — | Baseline | +3.0% | +3.0% |
| on HEFA Basis | | | | | | |

### SPECIFIC EMBODIMENTS

While the following is described in conjunction with specific embodiments, it will be understood that this description is intended to illustrate and not limit the scope of the preceding description and the appended claims.

A first embodiment of the invention is a process for co-processing Fischer-Tropsch products and fats, oils, and greases (FOGs) comprising hydrocracking a feed stream comprising Fischer-Tropsch products comprising C₅-C₁₀₀ normal paraffins and FOGs in a hydrocracking reaction zone comprising a hydrocracking reactor to form a hydrocracked effluent stream comprising C₅-C₂₀ normal paraffins; dewaxing the hydrocracked effluent stream in a dewaxing reaction zone comprising a dewaxing reactor to form a dewaxed effluent stream comprising C₅-C₂₀ normal paraffins and isoparaffins; and separating the dewaxed effluent stream into at least a synthetic paraffinic kerosene stream comprising C₈-C₂₀ normal paraffins and isoparaffins, and an unconverted oil stream comprising C₂₁₊ normal paraffins and isoparaffins. An embodiment of the invention is one, any or all of prior embodiments in this paragraph up through the first embodiment in this paragraph further comprising recycling the unconverted oil stream to the hydrocracking reaction zone. An embodiment of the invention is one, any or all of prior embodiments in this paragraph up through the first embodiment in this paragraph wherein separating the dewaxed effluent stream into at least the synthetic paraffinic kerosene, and the unconverted oil stream comprises separating the dewaxed effluent stream into at least the synthetic paraffinic kerosene stream, the unconverted oil stream, and a naphtha stream comprising C₅-C₈ normal paraffins and isoparaffins, or a fuel gas stream comprising fuel gas and liquified petroleum gas, or a hydrogen stream, or combinations thereof. An embodiment of the invention is one, any or all of prior embodiments in this paragraph up through the first embodiment in this paragraph wherein a hydrogen stream is recovered from the product recovery zone and recycled to the hydrocracking zone, or the dewaxing zone, or both. An embodiment of the invention is one, any or all of prior embodiments in this paragraph up through the first embodiment in this paragraph further comprising demetallizing and hydrodeoxygenating the FOGs stream in a demetallizing and hydrodeoxygenating reaction zone comprising a demetallizing and hydrodeoxygenating reactor before hydrocracking the feed stream. An embodiment of the invention is one, any or all of prior embodiments in this paragraph up through the first embodiment in this paragraph wherein the Fischer-Tropsch product stream comprises C₅-C₁₀₀ normal paraffins, and further comprising demetallizing and hydrodeoxygenating a Fischer-Tropsch distillate stream comprising C₅-C₃₀ normal paraffins and the FOGs stream in a demetallizing and hydrodeoxygenating reaction zone comprising a demetallizing and hydrodeoxygenating reactor to form a demetallized Fischer-Tropsch distillate and FOGs stream; and wherein hydrocracking the feed stream comprising the Fischer-Tropsch products and the FOGs comprises hydrocracking the feed stream comprising the Fischer-Tropsch products and the demetallized Fischer-Tropsch distillate and FOGs stream.

A second embodiment of the invention is a process for co-processing Fischer-Tropsch products and fats, oils, and greases (FOGs) comprising hydrocracking a feed stream comprising Fischer-Tropsch products comprising C₅-C₁₀₀ normal paraffins in a hydrocracking reaction zone comprising a hydrocracking reactor to form a hydrocracked effluent stream comprising C₅-C₂₀ normal paraffins; and dewaxing the hydrocracked effluent stream, a Fischer-Tropsch distillate stream comprising C₅-C₃₀ normal paraffins, and a FOGs stream comprising C₅-C₃₀ FOGs in a dewaxing reaction zone comprising a dewaxing reactor to form a dewaxed effluent stream comprising C₅-C₂₀ normal paraffins and isoparaffins; separating the dewaxed effluent stream into at least a synthetic paraffinic kerosene stream comprising C₈-C₂₀ normal paraffins and isoparaffins, and an unconverted oil stream comprising C₂₁₊ normal paraffins and isoparaffins. An embodiment of the invention is one, any or all of prior embodiments in this paragraph up through the second embodiment in this paragraph further comprising recycling the unconverted oil stream to the hydrocracking reaction zone. An embodiment of the invention is one, any or all of prior embodiments in this paragraph up through the second embodiment in this paragraph wherein separating the dewaxed effluent stream into at least the synthetic paraffinic kerosene, and the unconverted oil stream comprises separating the dewaxed effluent stream into at least the synthetic paraffinic kerosene stream, the unconverted oil stream, and a naphtha stream comprising C₅-C₈ normal paraffins and isoparaffins, or a fuel gas stream comprising fuel gas and liquified petroleum gas, or a hydrogen stream, or combinations thereof. An embodiment of the invention is one, any or all of prior embodiments in this paragraph up through the second embodiment in this paragraph further comprising demetallizing and hydrodeoxygenating the FOGs stream before dewaxing the hydrocracked effluent stream, the Fischer-Tropsch distillate stream, and the FOGs stream. An embodiment of the invention is one, any or all of prior embodiments in this paragraph up through the second embodiment in this paragraph wherein the Fischer-Tropsch product stream comprises C₅-C₁₀₀ normal paraffins, further comprising demetallizing and hydrodeoxygenating the Fischer-Tropsch distillate stream comprising C₅-C₃₀ normal paraffins and the FOGs stream in a demetallizing and hydrodeoxygenating reaction zone comprising a demetallizing and hydrodeoxygenating reactor to form a demetallized Fischer-Tropsch distillate and FOGs stream; and wherein dewaxing the hydrocracked effluent stream, the Fischer-Tropsch distillate stream, and the FOGs stream comprises dewaxing the hydrocracked effluent stream and the demetallized Fischer-Tropsch distillate and FOGs stream. An embodiment of the invention is one, any or all of prior embodiments in this paragraph up through the second embodiment in this paragraph wherein a hydrogen stream is recovered from the product recovery zone and recycled to the hydrocracking zone, or the dewaxing zone, or both.

A third embodiment of the invention is a process for co-processing Fischer-Tropsch products and fats, oils, and greases (FOGs) comprising dewaxing a feed stream comprising a Fischer-Tropsch product stream comprising a Fischer-Tropsch distillate stream comprising C₅-C₃₀ normal paraffins, and a FOGs stream comprising C₅-C₁₀₀ FOGs in a dewaxing reaction zone comprising a dewaxing reactor to form a dewaxed effluent stream comprising C₅-C₁₀₀ normal paraffins and isoparaffins; hydrocracking at least a portion of the dewaxed effluent stream in a hydrocracking reaction zone comprising a hydrocracking reactor to form a hydrocracked effluent stream comprising C₅-C₂₀ normal paraffins and isoparaffins; and separating the hydrocracked effluent stream into at least a synthetic paraffinic kerosene stream comprising C₈-C₂₀ normal paraffins and isoparaffins, and an unconverted oil stream comprising C₂₁₊ normal paraffins and isoparaffins. An embodiment of the invention is one, any or all of prior embodiments in this paragraph up through the third embodiment in this paragraph further comprising recycling the unconverted oil stream to the dewaxing reaction zone. An embodiment of the invention is one, any or all of prior embodiments in this paragraph up through the third embodiment in this paragraph wherein separating the hydrocracked effluent stream into at least the synthetic paraffinic kerosene, and the unconverted oil stream comprises separating the dewaxed effluent stream into at least the synthetic paraffinic kerosene stream, the unconverted oil stream, and a naphtha stream comprising C₅-C₈ normal paraffins and isoparaffins, or a fuel gas stream comprising fuel gas and liquified petroleum gas, or a hydrogen stream, or combinations thereof. An embodiment of the invention is one, any or all of prior embodiments in this paragraph up through the third embodiment in this paragraph further comprising demetallizing and hydrodeoxygenating the FOGs stream before dewaxing the feed stream. An embodiment of the invention is one, any or all of prior embodiments in this paragraph up through the third embodiment in this paragraph further comprising demetallizing and hydrodeoxygenating the Fischer-Tropsch distillate stream and the FOGs stream in a demetallizing and hydrodeoxygenating reaction zone comprising a demetallizing and hydrodeoxygenating reactor to form a demetallized Fischer-Tropsch distillate and FOGs stream before dewaxing the feed stream; and wherein dewaxing the feed stream and the FOGs stream comprises dewaxing the demetallized Fischer-Tropsch distillate and FOGs stream and a second Fischer-Tropsch product stream comprising C₅-C₁₀₀ normal paraffins. An embodiment of the invention is one, any or all of prior embodiments in this paragraph up through the third embodiment in this paragraph wherein a hydrogen stream is recovered from the product recovery zone and recycled to the hydrocracking zone, or the dewaxing zone, or both.

A fourth embodiment of the invention is a process for upgrading Fischer-Tropsch oil to synthetic paraffinic kerosene comprising hydrocracking a feed stream comprising Fischer-Tropsch products comprising C₅-C₁₀₀ normal paraffins and a FOGs stream comprising C₅-C₁₀₀ FOGs in a hydrocracking reaction zone comprising a hydrocracking reactor to form a hydrocracked effluent stream comprising C₅-C₂₀ normal paraffins separating the hydrocracked effluent stream in a product recovery zone into at least a synthetic paraffinic kerosene stream comprising C₈ to C₂₀ normal paraffins and isoparaffins, and an unconverted oil stream comprising C₁₉₊ hydrocarbons; demetallizing and hydrodeoxygenating a second FOGs stream in a demetallizing and hydrodeoxygenating reaction zone comprising a demetallizing and hydrodeoxygenating reactor to form a demetallized FOGs stream; dewaxing the synthetic paraffinic kerosene stream and the demetallized FOGs stream in a dewaxing reaction zone comprising a dewaxing reactor in the presence of a dewaxing catalyst under dewaxing conditions to form a Fischer-Tropsch synthetic paraffinic kerosene and FOGs stream comprising C₈ to C₂₀ normal paraffins and isoparaffins. An embodiment of the invention is one, any or all of prior embodiments in this paragraph up through the fourth embodiment in this paragraph further comprising recycling the unconverted oil stream to the hydrocracking reaction zone. An embodiment of the invention is one, any or all of prior embodiments in this paragraph up through the fourth embodiment in this paragraph wherein separating the hydrocracked effluent stream into at least the synthetic paraffinic kerosene, and the unconverted oil stream comprises separating the dewaxed effluent stream into at least the synthetic paraffinic kerosene stream, the unconverted oil stream, and a naphtha stream comprising C₅-C₈ normal paraffins and isoparaffins, or a fuel gas stream comprising fuel gas and liquified petroleum gas, or a hydrogen stream, or combinations thereof. An embodiment of the invention is one, any or all of prior embodiments in this paragraph up through the fourth embodiment in this paragraph further comprising passing a hydrogen gas stream to the hydrocracking reaction zone, or the demetallizing and hydrodeoxygenating reaction zone, or the dewaxing reaction zone, or combinations thereof. An embodiment of the invention is one, any or all of prior embodiments in this paragraph up through the fourth embodiment in this paragraph wherein the hydrogen gas stream comprises a recycle hydrogen stream from the product recovery zone.

A fifth embodiment of the invention is a process for co-processing Fischer-Tropsch products and fats, oils, and greases (FOGs) comprising demetallizing and hydrodeoxygenating a FOGs stream comprising C₅-C₁₀₀ FOGs in a demetallizing and hydrodeoxygenating reaction zone comprising a demetallizing and hydrodeoxygenating reactor to form a demetallized FOGs stream; dewaxing a feed stream comprising Fischer-Tropsch products comprising C₅-C₁₀₀ normal paraffins and the demetallized FOGs stream in a dewaxing reaction zone comprising a dewaxing reactor to form a dewaxed effluent stream comprising C₅-C₁₀₀ normal paraffins and isoparaffins; separating the dewaxed effluent stream and a hydrocracked effluent stream from a hydrocracking reaction zone into at least a synthetic paraffinic kerosene stream comprising C₈-C₂₀ normal paraffins and isoparaffins, and an unconverted oil stream comprising C₂₁₊ normal paraffins and isoparaffins; hydrocracking the unconverted oil stream in the hydrocracking reaction zone comprising a hydrocracking reactor to form the hydrocracked effluent stream comprising C₅-C₂₀ normal paraffins and isoparaffins. An embodiment of the invention is one, any or all of prior embodiments in this paragraph up through the fifth embodiment in this paragraph wherein separating the dewaxed effluent stream and the hydrocracked effluent stream into at least the synthetic paraffinic kerosene, and the unconverted oil stream comprises separating the dewaxed effluent stream into at least the synthetic paraffinic kerosene stream, the unconverted oil stream, and a naphtha stream comprising C₅-C₈ normal paraffins and isoparaffins, or a fuel gas stream comprising fuel gas and liquified petroleum gas, or a hydrogen stream, or combinations thereof. An embodiment of the invention is one, any or all of prior embodiments in this paragraph up through the fifth embodiment in this paragraph further comprising passing a hydrogen gas stream to the hydrocracking reaction zone or the demetallizing and hydrodeoxygenating reaction zone or both. An embodiment of the invention is one, any or all of prior embodiments in this paragraph up through the fifth embodiment in this paragraph wherein the hydrogen gas stream comprises a recycle hydrogen stream from the product recovery zone.

What is claimed is:

1. A process for co-processing Fischer-Tropsch products and fats, oils, and greases (FOGs) comprising:
hydrocracking a feed stream comprising Fischer-Tropsch products comprising C₅-C₁₀₀ normal paraffins and a FOGs stream in a hydrocracking reaction zone comprising a hydrocracking reactor to form a hydrocracked effluent stream comprising C₅-C₂₀ normal paraffins;
dewaxing the hydrocracked effluent stream in a dewaxing reaction zone comprising a dewaxing reactor to form a dewaxed effluent stream comprising C₅-C₂₀ normal paraffins and isoparaffins; and
separating the dewaxed effluent stream into at least a synthetic paraffinic kerosene stream comprising C₈-C₂₀ normal paraffins and isoparaffins, and an unconverted oil stream comprising C₂₁₊ normal paraffins and isoparaffins.

2. The process of claim 1 further comprising:
recycling the unconverted oil stream to the hydrocracking reaction zone.

3. The process of claim 1 wherein separating the dewaxed effluent stream into at least the synthetic paraffinic kerosene stream, and the unconverted oil stream comprises separating the dewaxed effluent stream into at least the synthetic paraffinic kerosene stream, the unconverted oil stream, and a naphtha stream comprising C₅-C₈ normal paraffins and isoparaffins, or a fuel gas stream comprising fuel gas and liquified petroleum gas, or a hydrogen stream, or combinations thereof.

4. The process of claim 1 wherein a hydrogen stream is recovered from the product recovery zone and recycled to the hydrocracking zone, or the dewaxing zone, or both.

5. The process of claim 1 further comprising:
demetallizing and hydrodeoxygenating the FOGs stream in a demetallizing and hydrodeoxygenating reaction zone comprising a demetallizing and hydrodeoxygenating reactor before hydrocracking the feed stream.

6. The process of claim 1 wherein the Fischer-Tropsch product stream comprises C₅-C₁₀₀ normal paraffins, and further comprising:
demetallizing and hydrodeoxygenating a Fischer-Tropsch distillate stream comprising C₅-C₃₀ normal paraffins and the FOGs stream in a demetallizing and hydrodeoxygenating reaction zone comprising a demetallizing and hydrodeoxygenating reactor to form a demetallized Fischer-Tropsch distillate and FOGs stream; and
wherein hydrocracking the feed stream comprising the Fischer-Tropsch products and the FOGs comprises hydrocracking the feed stream comprising the Fischer-Tropsch products and the demetallized Fischer-Tropsch distillate and FOGs stream.

7. A process for co-processing Fischer-Tropsch products and fats, oils, and greases (FOGs) comprising:
hydrocracking a feed stream comprising Fischer-Tropsch products comprising C₅-C₁₀₀ normal paraffins in a hydrocracking reaction zone comprising a hydrocracking reactor to form a hydrocracked effluent stream comprising C₅-C₂₀ normal paraffins; and
dewaxing the hydrocracked effluent stream, a Fischer-Tropsch distillate stream comprising C₅-C₃₀ normal paraffins, and a FOGs stream comprising C₅-C₃₀ FOGs in a dewaxing reaction zone comprising a dewaxing reactor to form a dewaxed effluent stream comprising C₅-C₂₀ normal paraffins and isoparaffins; and
separating the dewaxed effluent stream into at least a synthetic paraffinic kerosene stream comprising C₈-C₂₀ normal paraffins and isoparaffins, and an unconverted oil stream comprising C₂₁₊ normal paraffins and isoparaffins.

8. The process of claim 7 further comprising:
recycling the unconverted oil stream to the hydrocracking reaction zone.

9. The process of claim 7 wherein separating the dewaxed effluent stream into at least the synthetic paraffinic kerosene, and the unconverted oil stream comprises separating the dewaxed effluent stream into at least the synthetic paraffinic kerosene stream, the unconverted oil stream, and a naphtha stream comprising C₅-C₈ normal paraffins and isoparaffins, or a fuel gas stream comprising fuel gas and liquified petroleum gas, or a hydrogen stream, or combinations thereof.

10. The process of claim 7 further comprising:
demetallizing and hydrodeoxygenating the FOGs stream before dewaxing the hydrocracked effluent stream, the Fischer-Tropsch distillate stream, and the FOGs stream.

11. The process of claim 7 wherein the Fischer-Tropsch product stream comprises C₅-C₁₀₀ normal paraffins, further comprising:
demetallizing and hydrodeoxygenating the Fischer-Tropsch distillate stream comprising C₅-C₃₀ normal paraffins and the FOGs stream in a demetallizing and hydrodeoxygenating reaction zone comprising a demetallizing and hydrodeoxygenating reactor to form a demetallized Fischer-Tropsch distillate and FOGs stream; and
wherein dewaxing the hydrocracked effluent stream, the Fischer-Tropsch distillate stream, and the FOGs stream comprises dewaxing the hydrocracked effluent stream and the demetallized Fischer-Tropsch distillate and FOGs stream.

12. A process for co-processing Fischer-Tropsch products and fats, oils, and greases (FOGs) comprising:
dewaxing a feed stream comprising a Fischer-Tropsch product stream comprising a Fischer-Tropsch distillate stream comprising C₅-C₃₀ normal paraffins, and a FOGs stream comprising C₅-C₁₀₀ FOGs in a dewaxing reaction zone comprising a dewaxing reactor to form a dewaxed effluent stream comprising C₅-C₁₀₀ normal paraffins and isoparaffins;
hydrocracking at least a portion of the dewaxed effluent stream in a hydrocracking reaction zone comprising a hydrocracking reactor to form a hydrocracked effluent stream comprising C₅-C₂₀ normal paraffins and isoparaffins; and
separating the hydrocracked effluent stream into at least a synthetic paraffinic kerosene stream comprising C₈-C₂₀ normal paraffins and isoparaffins, and an unconverted oil stream comprising C₂₁₊ normal paraffins and isoparaffins.

13. The process of claim 12 further comprising:
recycling the unconverted oil stream to the dewaxing reaction zone.

14. The process of claim 12 wherein separating the hydrocracked effluent stream into at least the synthetic paraffinic kerosene, and the unconverted oil stream comprises separating the dewaxed effluent stream into at least the synthetic paraffinic kerosene stream, the unconverted oil stream, and a naphtha stream comprising C₅-C₈ normal paraffins and isoparaffins, or a fuel gas stream comprising fuel gas and liquified petroleum gas, or a hydrogen stream, or combinations thereof.

15. The process of claim 12 further comprising:
demetallizing and hydrodeoxygenating the FOGs stream before dewaxing the feed stream.

16. The process of claim 12 further comprising:
demetallizing and hydrodeoxygenating the Fischer-Tropsch distillate stream and the FOGs stream in a demetallizing and hydrodeoxygenating reaction zone comprising a demetallizing and hydrodeoxygenating reactor to form a demetallized Fischer-Tropsch distillate and FOGs stream before dewaxing the feed stream; and
wherein dewaxing the feed stream and the FOGs stream comprises dewaxing the demetallized Fischer-Tropsch distillate and FOGs stream and a second Fischer-Tropsch product stream comprising C₅-C₁₀₀ normal paraffins.
